(19) United States
(12) Patent Application Publication
(10) Pub. No.: US 2020/0160298 A1
(43) Pub. Date: May 21, 2020

(54) METHODS AND SYSTEMS FOR LINKING TOKENIZED DATA

(71) Applicant: MASTERCARD INTERNATIONAL INCORPORATED, Purchase, NY (US)

(72) Inventor: DANIEL BRIAN O'SULLIVAN, White Plains, NY (US)

(21) Appl. No.: 16/195,366

(22) Filed: Nov. 19, 2018

(51) Int. Cl. G06Q 20/10

(52) U.S. Cl. CPC G06Q 20/105

(57) ABSTRACT

Provided are methods and systems for improving data tokenization processes and mobile device data accessibility. A data warehouse may receive first provisioning data for tokenizing a first data set and a device identifier for a mobile device. The tokenized first data set may be stored in a database record associated with the device identifier. The data warehouse may receive second provisioning data for tokenizing a second data set and the device identifier. The data warehouse may then determine that both tokenized data sets are associated with the mobile device based on the device identifier. When the tokenized first data set is used by the mobile device, the data warehouse may notify a network associated with the second data set. The network may update its data processing rules based on the notification.

### BACKGROUND

In an increasingly complex digital world, data protection and privacy have become paramount. Data warehouses and related entities that hold large amounts of personally identifiable information are tasked with the dual role of safeguarding sensitive data while simultaneously ensuring that it is accessible by the proper parties. Current methods of safeguarding sensitive data can at times lead to a degradation of data accessibility. The drawbacks of these current methods are especially pronounced in the realm of mobile devices, which have become repositories of personally identifiable information as well as a common form of identification in digital aspects. With respect to mobile devices, data tokenization has become a popular tool for safeguarding sensitive data; however, current methods that implement data tokenization do not provide a high level of data accessibility. Thus, what is needed are systems and methods that improve data tokenization processes and mobile device data accessibility. These and other considerations are addressed by the present disclosure.

### SUMMARY

It is to be understood that both the following general description and the following detailed description are exemplary and explanatory only and are not restrictive. Methods and systems are described herein relating to, among other things, providing cross-issuer notification of a cardholder's travel arrangements without requiring personally identifiable information. When a cardholder tokenizes a payment card stored in an electronic wallet on a user device, a payment network may receive related provisioning data such as a first primary account number (PAN) and a first device identifier. The first PAN and the first device identifier may be stored by the payment network in a database record associated with the cardholder. When a second payment card is tokenized by the cardholder with the same user device, additional provisioning data such as a second PAN associated with the second payment card may be received by the payment network. The additional provisioning data may also include the first device identifier—indicating that the second payment card is being added to the same electronic wallet. The payment network may then determine, based on the first device identifier, that the first PAN and the second PAN are each associated with the same electronic wallet. The payment network may then generate a database relationship linking a data record containing the first PAN and the first device identifier with a second data record containing the second PAN and the first device identifier. This may be accomplished by storing in the first data record a reference to the second data record. Likewise, a reference to the first data record may be stored in the second data record. In this way, when two PANs are tokenized using the same user device (e.g. a smart phone, mobile device, tablet, etc.), the payment network may determine that both PANs are issued to the same cardholder (e.g., the owner of the user device). With this information, the payment network may coordinate fraud prevention policies and other information services between each issuer of each PAN.

After the first and second PANs have been provisioned, the payment network may then receive a travel transaction record associated with the first PAN. The travel transaction record may include several data fields that hold information regarding the transaction. A given data field may indicate one or more travel dates associated with the travel transaction. Another data field may indicate one or more travel locations associated with the travel transaction. The payment network may search the database for the first data record associated with the first PAN. Based on the reference to the second data record that was stored in the first data record, as well as the first device identifier stored in each data record, it may be determined that the first PAN and the second PAN are associated with a single cardholder.

Further, based on several digits of the first PAN and several digits of the second PAN that indicate respective issuers, it may be determined that the first PAN is associated with a first issuer and the second PAN is associated with a second issuer. The payment network may then send a message to the second issuer identifying the second PAN, the one or more travel dates, and the one or more travel locations. In this way, the second issuer may update their fraud prevention rules with respect to the cardholder such that transactions initiated by the cardholder at the travel locations on one or more of the travel dates may be prevented from being declined. Moreover, no personally identifiable information is required other than the first PAN, the second PAN, and the device identifier.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems: FIG. 1A is a flow chart of an exemplary method;

FIG. 1B is a flow chart of an exemplary method;

FIG. 2 is a block diagram of an exemplary operating environment;

FIG. 3 is a flow chart of an exemplary method;

FIG. 4 is a flow chart of an exemplary method;

FIG. 5 is a flow chart of an exemplary method; and

FIG. 6 is a block diagram of an exemplary computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

Further, it is to be understood that all embodiments of the methods and systems described herein, or otherwise contemplated by the present descriptions, are intended to be implemented in compliance with all relevant government regulations and policies. Such government regulations and policies include, but are not limited to, the General Data Protection Regulation of the European Union, the California Consumer Privacy Act, and the like. Accordingly, all uses of data and PII (e.g., of cardholders) described herein are with the consent of the associated person(s). No data or PII is shared with, or otherwise disclosed to, third-parties absent consent received from the associated person(s).

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided herein are methods and systems for improving data processing, such as transaction processing, by data warehouses, such as payment networks. The methods and systems provided herein also improve the implementation of fraud prevention rules by payment card issuers. Payment networks may act as intermediaries between payment card issuers, which are typically associated with an issuer and merchant processing systems/banks. Payment networks receive transaction data from merchants (e.g., from a merchant point of sale system (“POS”) and/or an acquirer bank associated with a merchant) and ensure that transactions associated with transaction data are appropriately processed and passed on to an issuer of a given payment card. Payment networks must therefore maintain data associated with each issuer, payment card account (“PAN”) number, and acquirer/merchant.

Due to security and privacy concerns, payment networks retain as little data as possible. Personally identifiable information (“PII”) associated with PANs, such as accountholder date of birth, social security number, or even name, are often walled-off from payment networks in order to comply with applicable laws, privacy practices, security policies, etc. Thus, although an individual may be associated with several payment cards—and therefore several unique PANs—the payment network typically does not retain PII that would be necessary to cross-reference each of the PANs with the individual. As a result, an issuer of PAN “A” (e.g., a payment card) is not apprised of transactions initiated by the individual associated with PAN “A” when he or she uses PAN “B” (e.g., another payment card) issued by a separate issuer. As each PAN is unique—and the necessary PII is not available—the payment network may be unable to cross-reference PAN “A” with PAN “B.” At times, however, it may beneficial if the payment network were able to apprise the issuer of PAN “A” of certain details of transactions initiated by the individual using PAN “B.” For example, when the individual books travel accommodations (e.g., flights, hotels, train/bus tickets, etc.) with PAN “B,” it may be beneficial to the issuer of PAN “A” to be aware of the upcoming travel so that fraud prevention rules associated with PAN “A” may be updated based on the travel.

Most issuers implement processing rules that are designed to prevent transaction fraud. This is especially common with respect to out-of-state or out-of-country purchases (e.g., transactions originating from location “A” using a PAN associated with location “B,” which may be out-of-state or in another country with respect to location “A”). These fraud prevention rules are beneficial to accountholders and issuers, but they can cause processing delays and unnecessary network traffic when they are applied in error. This may occur after an individual books travel accommodations for location “A” (e.g., a flight/train/bus ticket to location “A,” a hotel at location “A,” etc.) with PAN “A” issued by issuer “A.” Once the individual arrives at location “A,” he or she may then initiate a transaction using PAN “B” issued by issuer “B.” Since issuer “B” was not apprised of the individual's travel to location “A” (e.g., the payment network may not have the necessary PII to cross-reference PAN “A” with PAN “B”), fraud prevention rules implemented by issuer “B” may unnecessarily cause processing delays and unnecessary network traffic for the payment network (e.g., blocking, delaying, or declining transactions that are falsely determined to be fraudulent). This may mean a delay in processing the transaction (e.g., transaction data for the transaction is stored at the payment network until issuer “B” determines whether the transaction is not fraudulent and should be approved or it is fraudulent and should be declined). This may also mean the transaction is immediately declined by issuer “B” (e.g., the payment network receives the transaction data, processes it, and soon thereafter receives a message indicative of a rejection by the merchant or acquirer bank). In the first scenario, the payment network may be burdened with storing the transaction data until such a time the transaction is approved or declined. This may lead to excess and unnecessary memory usage as well as decreased bandwidth while issuer “B” is making its determination (e.g., payment network databases would be holding/storing transaction data for a transaction that is not actually fraudulent). In the second scenario, the payment network may be burdened by the need to process a second, identical transaction at a later time (e.g., after the individual contacts issuer “B” and informs them of the travel). This causes excess network traffic and dedication of resources at the payment network (e.g., the second transaction only occurs due to the first transaction falsely determined to be fraudulent).

In order to avoid processing delays and unnecessary network traffic at payment networks when issuer fraud prevention rules are unnecessarily applied to payment card transactions, the present methods and systems leverage the intermediary nature of payment networks with PAN tokenization. As discussed above, payment networks avoid retaining PII that is associated with a PAN. One method of retaining identifying data associated with a PAN that is not PII is to utilize tokenization. The term “tokenize” and/or “tokenization,” as used herein, refers to providing a token (e.g., alphanumeric identifier) that is associated with an individual's PAN by a token service provider, which may be a payment network, an issuer associated with the PAN to be tokenized, or the like. A token is typically a non-sensitive data element that is substituted for the numeric PAN (e.g., a 16-digit number/identifier that differs from the PAN). Because a token is not merely an encrypted representation of the PAN, it is therefore useless if stolen or otherwise obtained by a third party.

An individual may tokenize his or her PAN using an application executing on a mobile device or other computing device. This may be achieved by the individual opening/launching a “wallet application” on the mobile device or other computing device and entering his or her PAN and associated information. The mobile device or other computing device may have an electronic wallet application stored therein. The electronic wallet application may be hosted by a payment network or an issuer associated with the PAN to be tokenized. The electronic wallet application may be compatible with MASTERCARD MASTERPASS, APPLE PAY, GOOGLE PAY, SAMSUNG PAY, and the like. The individual, using the electronic wallet application, may manually type the PAN directly into the electronic wallet application, or it may be done via a snapshot(s) of a payment card associated with the PAN (e.g., using object character recognition to extract alphanumeric characters from the snapshot(s)). The individual may also tokenize his or her PAN using a web interface in communication with the payment network and/or an issuer network associated with the PAN. The web interface may operate and/or present in a similar manner as with the application on the mobile device or other computing device.

Information provided by the user during the tokenization process (e.g., provisioning process) may include account information such as the PAN itself, an associated expiration date and/or security code, and the like. All associated information received by the token service network during the tokenization process, along with the PAN, may be stored in a secure repository at the token service provider and associated with a generated, unique token (e.g., token number, token identifier, etc.). Each token may be associated with a device identifier for the mobile device or other computing device the individual uses during the tokenization process. A device identifier may be a Mobile Station International Subscriber Directory Number (“MSISDN”), an International Mobile Equipment Identity (“IMEI”) number for a mobile device, a wallet identifier for an electronic wallet or wallet mobile application, a Media Access Control (“MAC”) address for a mobile device or other computing device, a serial number for a mobile device or other computing device, and the like.

The PAN and all associated information that is tokenized may be referred to herein as “the tokenized PAN” or simply “the token,” and the identifier for the mobile device or other computing device the individual uses during the tokenization process may be referred to as a “device identifier.” Data indicating an association of the token to the PAN and the device identifier may be held in a “Token Vault,” which may be a database, server, server farm, or the like. The Token Vault may store the token (e.g., a token identifier for the tokenized PAN) as well as the PAN and the device identifier in a data structure within the Token Vault. A data structure for a tokenized PAN may also store references (e.g., locations in memory of the Token Vault) to data structures for other tokens associated with a single mobile device or computing device (e.g., a single device identifier). A single mobile device or computing device may be used to tokenize multiple PANs and each data structure for each tokenized PAN may be cross-referenced in the data structures for the other tokenized PANs. In this way, a device identifier for a single mobile device or computing device may be used by the token service provider to determine whether a given tokenized PAN is associated with other tokenized PANs.

The Token Vault may be maintained by a token service provider (e.g., a payment network, an issuer network associated with the tokenized PAN, a third party service provider, or the like). The tokenized PAN may conform to a format that is recognizable by merchants (e.g., merchant point of sale devices, merchant banks, etc.) as being a valid form of payment (e.g., recognized in the same way the tokenized PAN would be if it were used). The format of the tokenized PAN may be an International Standards Organization (ISO) message. The tokenized PAN may be fifteen, sixteen, eighteen or nineteen digits in length. Thus, a numeric identifier for the tokenized PAN may be compatible within ISO message format.

A portion of the tokenized PAN may be a series of characters, numbers, or other identifiers that may be used to identify the issuer associated with the tokenized PAN. The portion of the tokenized PAN may be a Bank Identification Number (“BIN”) or Issuer identification number (“IIN”) (collectively referred to herein as “BIN”) that indicates an issuer associated with the PAN. The BIN may be a six digit numeric string/value that may be associated with the issuer. The issuer may be indicated using a corresponding issuer identifier range associated with the BIN. As an example, an identifier for the issuer associated with the tokenized PAN may be “230000,” which may correspond to an identifier for the tokenized PAN (or the token's numeric value) of “2300001,” which in turn may be mapped to a BIN of “515520” corresponding to the PAN itself of “5155200012365478.”

After a PAN is provisioned and tokenized, the tokenized PAN may be sent from the token service provider to the mobile device or other computing device based on the device identifier associated with the tokenized PAN. The tokenized PAN may then be stored in the mobile device or other computing device and used in place of the PAN for transactions with merchants who accept tokenized PANs. The merchant may be a brick-and-mortar establishment using point of sale devices that are compatible with digital wallets. The merchant may also be online, in which case the tokenized PAN may be entered into a web interface in communication with the merchant and/or token service provider. The mobile device or other computing device may be capable of sending the tokenized PAN to the merchant point of sale device using RFID communication (e.g., near-field communication, Bluetooth™ etc.), or the like.

Once received, the merchant point of sale device (or web interface, as the case may be) may send data associated with the transaction, including the tokenized PAN, to the token service provider (e.g., via the payment network). This may be accomplished using existing communication protocols that the merchant may use to processing transactions involving a traditional payment card (e.g., credit card, debit card, gift card, etc.). The token service provider may then “detokenize” the tokenized PAN received from the merchant. This may be accomplished by the token service provider locating the data structure in the Token Vault associated with the tokenized PAN. The token service provider may then determine a value for the PAN itself that is stored in the data structure associated with the tokenized PAN. The token service provider may then send the value for the PAN itself along with the transaction data to an issuer associated with the PAN via the payment network for further processing of the transaction.

The data structure associated with the received tokenized PAN may contain cross-references to one or more other data structures, each being associated with a single device identifier (e.g., a single mobile device or computing device) and a unique tokenized PAN. The one or more other data structures may each be associated with a tokenized PAN and a unique issuer or a same issuer as the tokenized PAN received from the merchant point of sale device. Using the portion of each tokenized PAN indicative of a BIN associated with the respective issuer(s), the token service provider may determine which issuer is associated with each PAN. The token service provider and/or the payment network may then send certain portions of transaction data to the issuer, or issuers, associated with each PAN.

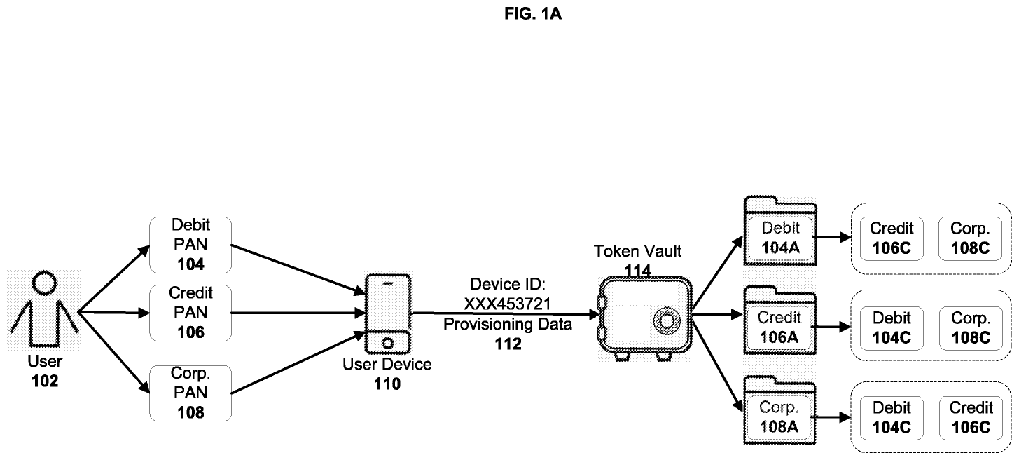

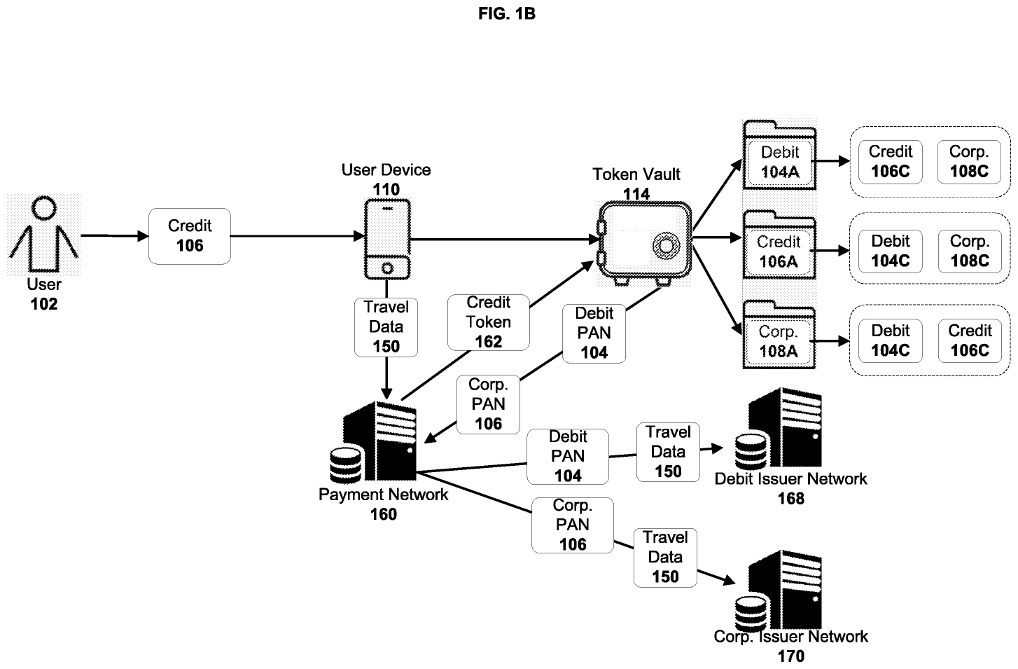

FIG. 1A shows a flowchart of a process by which a user 102 may tokenize his or her payment card PANs 104, 106, 108. The user 102 may use a “wallet application” executing on a user device 110 (e.g., a mobile device or other computing device) to tokenize a first PAN 104 associated with a debit card. The user device may send provisioning data 112 associated with tokenizing the first PAN 104 to a payment network. The provisioning data may include the first PAN 104, an associated expiration date and/or security code, and an identifier for the user device 110. The payment network may store the provisioning data 112 in a secure repository such as Token Vault 114. The provisioning data for the first PAN 104 may be associated with a first token (e.g., token number, token identifier, etc.). The first token may be associated with the identifier for the user device 110. The device identifier may be a Mobile Station International Subscriber Directory Number (“MSISDN”), an International Mobile Equipment Identity (“IMEI”) number for a mobile device, a wallet identifier for an electronic wallet or wallet mobile application, a Media Access Control (“MAC”) address for a mobile device or other computing device, a serial number for a mobile device or other computing device, and the like.

The Token Vault 114 may store the first token, the first PAN 104, first mapping data (e.g., data cross-referencing the first token with the first PAN 104), and the device identifier in a first data structure 104A within the Token Vault 114. The user 102 may subsequently use the wallet application on the user device 110 to tokenize a second PAN 106 associated with a credit card. The user device 110 may send provisioning data 112 associated with tokenizing the second PAN 106 to the payment network. The provisioning data for the second PAN 106 may include the second PAN 106, an associated expiration date and/or security code, and the identifier for the user device 110. The provisioning data for the second PAN 106 may be associated with a second token (e.g., token number, token identifier, etc.). The second token may be associated with the identifier for the user device 110. The Token Vault 114 may then store the second token, the second PAN 106, second mapping data (e.g., data cross-referencing the second token with the second PAN 106), and the device identifier in a second data structure 106A. The user 102 may again use the wallet application on the user device 110 to tokenize a third PAN 108 associated with a corporate credit card. The user device 110 may send provisioning data 112 associated with tokenizing the third PAN 108 to the payment network. The provisioning data for the third PAN 108 may include the third PAN 108, an associated expiration date and/or security code, and the identifier for the user device 110. The provisioning data for the third PAN 106 may be associated with a third token (e.g., token number, token identifier, etc.). The third token may be associated with the identifier for the user device 110. The Token Vault 114 may then store the third token, the third PAN 108, third mapping data (e.g., data cross-referencing the third token with the third PAN 108), and the identifier for the user device 110 in a third data structure 108A.

Based on the identifier for the user device 110 being associated with the first token, the second token, and the third token, the Token Vault 114 may cross-reference each data structure. This may be accomplished by the Token Vault 114 storing in the first data structure 104A a reference 106C (e.g., memory pointer, database cross-reference, etc.) associated with a location in the Token Vault 114 (e.g., memory address, database entry, etc.) where the second data structure 106A is stored. The Token Vault 114 may also store in the first data structure 104A a reference 108C (e.g., memory pointer, database cross-reference, etc.) associated with a location in the Token Vault 114 (e.g., memory address, database entry etc.) where the third data structure 108A is stored.

The Token Vault 114 may then store in the second data structure 106A a reference 104C (e.g., memory pointer, database cross-reference, etc.) associated with a location in the Token Vault 114 (e.g., memory address, database entry etc.) where the first data structure 104A is stored. The Token Vault 114 may also store in the second data structure 106A the reference 108C (e.g., memory pointer, database cross-reference, etc.) associated with the location in the Token Vault 114 (e.g., memory address, database entry etc.) where the third data structure 108A is stored. The Token Vault 114 may then store in the third data structure 108A the reference 104C (e.g., memory pointer, database cross-reference, etc.) associated with the location in the Token Vault 114 (e.g., memory address, database entry etc.) where the first data structure 104A is stored. The Token Vault 114 may also store in the third data structure 108A the reference 106C (e.g., memory pointer, database cross-reference, etc.) associated with the location in the Token Vault 114 (e.g., memory address, database entry etc.) where the second data structure 106A is stored.

FIG. 1B shows a flowchart of a process whereby a user 102 initiates a payment transaction for travel arrangements (e.g., airline ticket, bus fare, rail ticket, hotel, rental car, etc.) using a tokenized PAN stored on his or her user device 110. The user 102 may send the token associated with the credit card PAN 106 to a merchant point of sale device (e.g., via RFID communication, near-field communication, Bluetooth™, website interface, etc.). The merchant point of sale device (or web interface, as the case may be) may send transaction data associated with the transaction, such as the token associated with the second PAN 106 (Credit Token 162) and travel data 150, to a payment network 160. The transaction data may additionally contain data elements as defined in the International Organization for Standardization standard for systems that exchange electronic transactions made by cardholders using payment cards (e.g., ISO3). The travel data 150 may indicate one or more travel dates as well as he one or more travel locations associated with the travel arrangements. The Token Vault 114 may “detokenize” the Credit Token 162 by using the second mapping data to determine the value of the second PAN 106. The Token Vault 114 may then use the second PAN 106 to determine a location (e.g., in memory of the Token Vault 114) where the data structure associated with the second PAN 106 (e.g., the second data structure 106A) is stored. The Token Vault 114 may then determine that the second data structure 106A contains reference 104C to the first data structure 104A and reference 108C to the third data structure 108A. The Token Vault 114 may then send the first PAN 104 stored in the first data structure 104A to the payment network 160. The Token Vault 114 may also send the third PAN 108 stored in the third data structure 108A to the payment network 160.

Using a portion of each of the PANs 104, 106, 108, the payment network 160 may determine a BIN associated with each PAN 104, 106, 108. Based on each BIN, the payment network 160 may determine that neither the debit PAN 104 nor the corporate card PAN 108 are issued by an issuer identifier by the credit PAN 106. The payment network 160 may then send the debit PAN 104 and the travel data 150 (e.g., the one or more travel dates as well as the one or more travel locations associated with the travel arrangements) to debit issuer network 168. The payment network 160 may also send the corporate card PAN 106 and the travel data 150 to corporate issuer network 167. The debit issuer network 168 and the corporate issuer network 167 may each update their respective fraud prevention rules such that transactions initiated by the cardholder at the travel locations on one or more of the travel dates may be prevented from being declined.

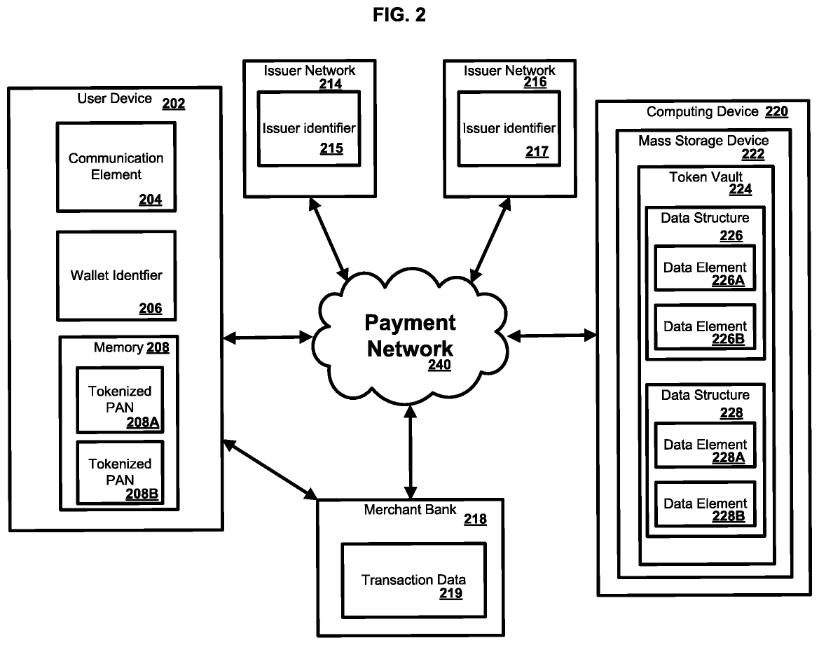

FIG. 2 shows an environment in which the present methods and systems may operate. One or more network devices may be configured to provide various services to one or more devices, such as devices located at or near a merchant location. Those skilled in the art will appreciate that the present methods and systems may be used in various types of networks and systems that employ both digital and analog equipment. One skilled in the art will appreciate that provided herein is a functional description and that the respective functions can be performed by software, hardware, or a combination of software and hardware.

Provided herein are methods and systems for improving transaction processing by payment networks and implementation of fraud prevention rules by payment card issuers. Payment network 240 may act as an intermediary or clearinghouse for an electronic wallet transaction initiated with a user device 202 and provided to a merchant bank 218 (e.g., via a merchant point of sale system) using communication element 204 of the user device 202. The communication element 204 may be any interface for presenting and/or receiving information to/from the user, such as a selection of a tokenized PAN to be used for a given transaction. An example interface may be a communication interface such as a web browser (e.g., INTERNET EXPLORER®, MOZILLA FIREFOX®, GOOGLE CHROME®, SAFARI®, or the like), mobile device application (e.g., APPLE PAY, SAMSUNG PAY, MASTERCARD MASTERPASS, etc.) and the like. Other software, hardware, and/or interfaces can be used to provide communication between the user device 202 and the merchant bank 218 and the payment network 240. The communication element 204 may request or query various files from a local source and/or a remote source. The communication element 206 may transmit data to a local or remote device such as the payment network 240.

The user device 202 may be used to tokenize a first PAN and thus generate Tokenized PAN 208A (e.g., a PAN associated with a debit card issued by issuer network 214). The user device 202 may send provisioning data (e.g., provisioning data 112) associated with tokenizing the first PAN to the payment network 240 using the communication element 204. The provisioning data may include the first PAN, an associated expiration date and/or security code, and the wallet identifier 206. The payment network may store the provisioning data in a secure repository such as Token Vault 224. The payment network 240 may facilitate communication between the user device 202 and a computing device 220 (e.g., a server, server farm, etc., associated with the payment network 240) at which the Token Vault 224 may be located, such as in mass storage device 222 (e.g., memory, hard disk drive, solid state storage, etc.) of the computing device 220. The Token Vault 224 may store a plurality of files (e.g., digitally stored files associated with an electronic wallet, one or more tokenized PANs, etc.), cardholder identifiers or records, or other information. The Token Vault 224 may be disposed remotely from the computing device 220 and accessed via direct or indirect connection. The Token Vault 224 may instead be integrated with the computing system 220 (e.g., stored in mass storage device 222) or some other device or system.

The provisioning data for the first PAN may be associated with Tokenized PAN 208A, which may be generated by the payment network 240 and/or the computing device 222. Tokenized PAN 208A may be associated with the wallet identifier 206 of the user device 202. The wallet identifier 206 may be a Mobile Station International Subscriber Directory Number (“MSISDN”), an International Mobile Equipment Identity (“IMEI”) number for a mobile device, a wallet identifier for an electronic wallet or wallet mobile application, a Media Access Control (“MAC”) address for a mobile device or other computing device, a serial number for a mobile device or other computing device, and the like. The Token Vault 224 may store the Tokenized PAN 208A, the first PAN, first mapping data (e.g., data cross-referencing the Tokenized PAN 208A with the first PAN), and the wallet identifier 206 in Data Structure 226 within the Token Vault 224. The wallet identifier 206 may be stored in Data Element 226A of Data Structure 226. Tokenized PAN 208A, the first PAN associated with the Tokenized PAN 208A, as well as the mapping information linking Tokenized PAN 208A and the first PAN may be stored in Data Element 226B of Data Structure 226.

The user may subsequently use the wallet application on the user device 202 to tokenize a second PAN (e.g., associated with a credit card). The provisioning data for the second PAN may be associated with Tokenized PAN 208B, which may be generated by the payment network 240 and/or the computing device 222. Tokenized PAN 208B may be associated with the wallet identifier 206 of the user device 202. The Token Vault 224 may store the Tokenized PAN 208B, the second PAN, second mapping data (e.g., data cross-referencing the Tokenized PAN 208B with the second PAN), and the wallet identifier 206 in Data Structure 228 within the Token Vault 224. The wallet identifier 206 may be stored in Data Element 228A of Data Structure 228. Tokenized PAN 208B, the second PAN associated with the Tokenized PAN 208B, as well as the mapping information linking Tokenized PAN 208B and the second PAN may be stored in Data Element 228B of Data Structure 228.

Based on the wallet identifier 206 being associated with the both Tokenized PAN 208A and Tokenized PAN 208B, the Token Vault 224 may cross-reference Data Structure 226 and Data Structure 228. This may be accomplished by the Token Vault 224 storing in Data Structure 226 (e.g., Data Element 226A, Data Element 226B, or an additional data element associated with Data Structure 226) a first reference (e.g., reference 106C, memory pointer, database cross-reference, etc.) associated with a location in the Token Vault 224 (e.g., memory address, database entry etc.) where Data Structure 228 is stored. The Token Vault 224 may also store in Data Structure 228 (e.g., Data Element 228A, Data Element 228B, or an additional data element associated with Data Structure 228) a second reference (e.g., reference 104C, memory pointer, database cross-reference, etc.) associated with a location in the Token Vault 224 (e.g., memory address, database entry etc.) where the Data Structure 226 is stored.

The user device 202 and the merchant bank 218 may be in communication via a private and/or public payment network such as the Internet or a local area network. Other forms of communications may be used such as wired and wireless telecommunication channels. The Transaction Data 219 (e.g., an ISO formatted transaction record) associated with a transaction initiated by the user device 202 may be indicative of (e.g., stored in one or more data fields of an ISO formatted transaction record) the wallet identifier 206 (e.g., device identifier) associated with the user device 202, Tokenized PAN 208A, and transaction addenda, which may include for example information related to travel arrangements (e.g., airline ticket, bus fare, rail ticket, hotel, rental car, etc.) purchased through the transaction (e.g., one or more travel dates as well as one or more travel locations associated with the travel arrangements).

The user device 202 may send the Transaction Data 219 to a merchant bank 218 (e.g., via a physical merchant point of sale device and/or a merchant website). The merchant bank 218 (or web interface, as the case may be) may send the Transaction Data 219 to the payment network 240, which may in turn send the Transaction Data 219 to the computing device 220 in order to be detokenized. The Token Vault 224 may detokenize the Tokenized PAN 208A by using the first mapping data stored in Data Structure 226 to determine a value of the first PAN (e.g., a 15 or 16 digit numerical identifier). The Token Vault 224 may then determine that Data Structure 226 contains a reference to Data Structure 228. The Token Vault 224 may detokenize the Tokenized PAN 208B by using the second mapping data stored in Data Structure 228 to determine a value of the second PAN (e.g., a 15 or 16 digit numerical identifier). The Token Vault 224 may then send the first PAN and the second PAN to the payment network 240.

Using a portion of the first PAN (e.g., the first 6 digits of the 15 or 16 digit numerical identifier), the payment network 240 may determine that the portion of the first PAN is indicative of issuer identifier 215 (e.g., a BIN) associated with issuer network 214. Using a portion of the second PAN (e.g., the first 6 digits of the 15 or 16 digit numerical identifier), the payment network 240 may determine that the portion of the second PAN is indicative of issuer identifier 217 (e.g., a BIN) associated with issuer network 216B.

The payment network 240 may then send the second PAN and one or more portions of the Transaction Data 219 (e.g., one or more data fields, ISO transaction record fields, etc.) indicative of the transaction addenda (e.g., one or more travel dates as well as one or more travel locations associated with the travel arrangements) to the issuer network 216B. The issuer network 216B may subsequently update their respective fraud prevention rules such that transactions initiated using the second PAN (e.g., Tokenized PAN 208B) at the travel locations on one or more of the travel dates may be prevented from being declined.

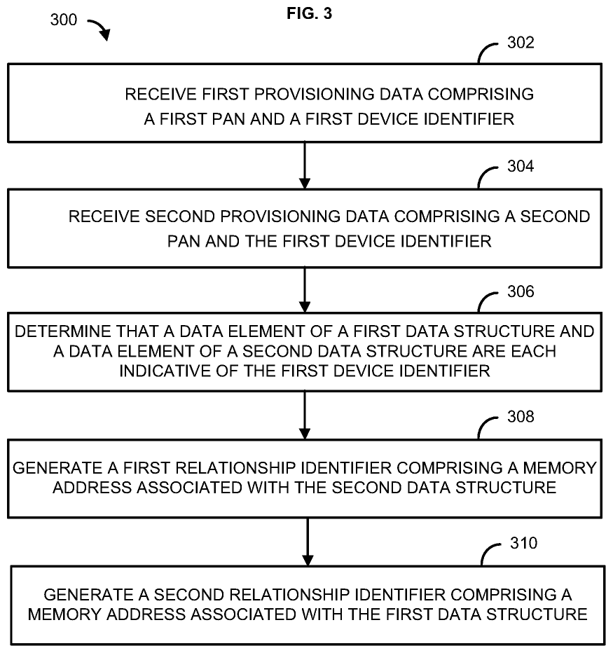

FIG. 3 shows an exemplary method 300 for linking tokenized PANs. At step 302, first provisioning data (e.g., provisioning data 112) may be received at a payment network (e.g., payment network 240) from a user device (e.g., user device 110; user device 202; etc.). The first provisioning data may indicate a first PAN (e.g., debit PAN 104, a unique string of at least fifteen digits, etc.) and a first device identifier (e.g., wallet identifier 206) associated with the user device. The first device identifier may be a cross-device electronic wallet identifier for an electronic wallet associated with more than one user device (e.g., an APPLE PAY WALLET, a SAMSUNG PAY WALLET, and/or a MASTERCARD MASTERPASS wallet accessible from both a mobile device and a computing device). The payment network may store a first tokenized PAN associated with the first PAN, first mapping data (e.g., data cross-referencing the first tokenized PAN with the first PAN), and the first device identifier in memory (e.g., in Token Value 114 and/or Token Vault 224) in a first data structure (e.g., first data structure 104A, Data Structure 226, etc.). The first data structure may include a plurality of data elements (e.g., reference 104C, 106C, 108C; Data Element 226A and Data Element 226B of Data Structure 226; etc.). The payment network may send the first tokenized PAN to the user device to be stored in an electronic wallet associated with the first device identifier.

At step 304, second provisioning data may be received at the payment network (e.g., payment network 240). The second provisioning data may indicate a second PAN (e.g., credit PAN 106, a unique string of at least fifteen digits, etc.) and the first device identifier (e.g., wallet identifier 206). The payment network may store a second tokenized PAN associated with the second PAN, second mapping data (e.g., data cross-referencing the second tokenized PAN with the second PAN), and the first device identifier in memory (e.g., in Token Value 114 and/or Token Vault 224) in a second data structure (e.g., second data structure 104B, Data Structure 228, etc.). The second data structure may include a plurality of data elements (e.g., reference 104C, 106C, 108C; Data Element 228A and Data Element 228B of Data Structure 228; etc.). While the first provisioning data may be received from a first user device, the second provisioning data may be received from a second user device. Both the first user device and the second user device may be associated with the cross-device electronic wallet identifier. The payment network may send the second tokenized PAN to the to one or more of the first user device or second user device to be stored in an electronic wallet associated with the first device identifier.

At step 306, the payment network may determine that a data element of the first data structure and a data element of the second data structure are each indicative of the first device identifier and/or the cross-device electronic wallet identifier. At step 308, based on the data element of the first data structure and the data element of the second data structure each being indicative of the first device identifier and/or the cross-device electronic wallet identifier, the payment network may generate a first relationship identifier (e.g., reference 104C, 106C, 108C, a memory pointer, a database cross-reference, etc.) that may be stored in a data element of the first data structure. The first relationship identifier may be indicative of a memory address associated with the second data structure. At step 310, the payment network may generate a second relationship identifier, which may be stored in a data element of the second data structure. The second relationship identifier may be generated based on the data element of the first data structure and the data element of the second data structure each being indicative of the first device identifier and/or the cross-device electronic wallet identifier. The second relationship identifier may be indicative of a memory address associated with the first data structure.

After the first PAN and the second PAN are tokenized, the payment network may receive a transaction record (e.g., Travel Data 150, Transaction Data 219, etc.) associated with a purchase of travel arrangements (e.g., airline ticket, bus fare, rail ticket, hotel, rental car, etc.) using the first tokenized PAN. The transaction record may contain transaction addenda, which may include information related to the travel arrangements (e.g., one or more travel dates, one or more travel locations, etc.). The payment network may then determine, based on the first mapping data, the first PAN associated with the first tokenized PAN. The payment network may also determine, based on the second mapping data, the second PAN associated with the second tokenized PAN. Based on the data element of the first data structure indicative of the first relationship identifier, the payment network may determine that the first PAN is associated with the second PAN.

Using a portion of the first PAN (e.g., the first 6 digits of the 15 or 16 digit numerical identifier), the payment network may determine that the portion of the first PAN is indicative of a first issuer identifier (e.g., a BIN) associated with a first issuer network. Using a portion of the second PAN (e.g., the first 6 digits of the 15 or 16 digit numerical identifier), the payment network may determine that the portion of the second PAN is indicative of second issuer identifier (e.g., a BIN) associated with a second issuer network. The payment network may then send the second PAN and one or more portions of the transaction record (e.g., one or more data fields, ISO transaction record fields, etc.) indicative of the transaction addenda to the second issuer network. The second issuer network may subsequently update their respective fraud prevention rules such that transactions initiated using the second PAN (e.g., the second tokenized PAN) at the travel locations on one or more of the travel dates may be prevented from being declined.

Third provisioning data may be received at the payment network. The third provisioning data may indicate the first PAN and a second device identifier associated with the cross-device electronic wallet identifier. The payment network may store the second device identifier in memory in the first data structure. The payment network may then determine that a data element of the first data structure and a data element of a third data structure associated with a third tokenized PAN are each indicative of the second device identifier. Based on the data element of the first data structure and the data element of the third data structure each being indicative of the second device identifier, the payment network may generate a third relationship identifier that may be stored in a data element of the first data structure. The third relationship identifier may be indicative of a memory address associated with the third data structure. Further, based on the data element of the first data structure and the data element of the third data structure each being indicative of the second device identifier, the payment network may generate a fourth relationship identifier associated with the first data structure, which may be stored in a data element of the third data structure.

The payment network may receive a second transaction record associated with a purchase of travel arrangements (e.g., airline ticket, bus fare, rail ticket, hotel, rental car, etc.) using the first tokenized PAN. The second transaction record may be contain transaction addenda, which may include information related to the travel arrangements. The payment network may then determine, based on the first mapping data, the first PAN associated with the first tokenized PAN. The payment network may also determine, based on the data element of the first data structure indicative of the third relationship identifier, that the first PAN is associated with the third PAN. Further, the payment network may determine, based on the data element of the first data structure indicative of the first relationship identifier, that the first PAN is associated with the second PAN.

Using a portion of the third PAN, the payment network may determine that the portion of the third PAN is indicative of a third issuer identifier associated with a third issuer network. The payment network may then send the second PAN and one or more portions of the transaction record indicative of the transaction addenda to the second issuer network. The second issuer network may subsequently update their respective fraud prevention rules such that transactions initiated using the second PAN (e.g., the second tokenized PAN) at the travel locations on one or more of the travel dates may be prevented from being declined. Additionally, the payment network may send the third PAN and one or more portions of the transaction record indicative of the transaction addenda to the third issuer network. The third issuer network may subsequently update their respective fraud prevention rules such that transactions initiated using the third PAN (e.g., the third tokenized PAN) at the travel locations on one or more of the travel dates may be prevented from being declined.

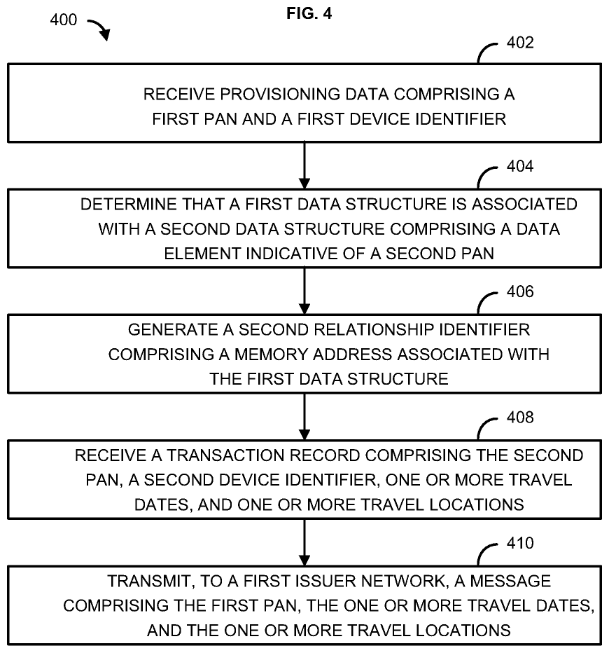

FIG. 4 shows an exemplary method 400 for linking tokenized PANs. At step 402, first provisioning data (e.g., provisioning data 112) may be received at a payment network (e.g., payment network 240) from a user device (e.g., user device 110; user device 202; etc.). The first provisioning data may indicate a first PAN (e.g., debit PAN 104, a unique string of at least fifteen digits, etc.) and a first device identifier (e.g., wallet identifier 206) associated with the user device. The first device identifier may be a cross-device electronic wallet identifier for an electronic wallet associated with more than one user device (e.g., an APPLE PAY WALLET, a SAMSUNG PAY WALLET, and/or a MASTERCARD MASTERPASS wallet accessible from both a mobile device and a computing device). The payment network may store a first tokenized PAN associated with the first PAN, first mapping data (e.g., data cross-referencing the first tokenized PAN with the first PAN), and the first device identifier in memory (e.g., in Token Value 114 and/or Token Vault 224) in a first data structure (e.g., first data structure 104A, Data Structure 226, etc.). The first data structure may include a plurality of data elements (e.g., reference 104C, 106C, 108C; Data Element 226A and Data Element 226B of Data Structure 226; etc.). The payment network may send the first tokenized PAN to the user device to be stored in an electronic wallet associated with the first device identifier.

At step 404, the payment network may determine, based on a data element of the first data structure indicative of a first relationship identifier, that the first data structure is associated with a second data structure. The first relationship identifier may be indicative of a memory address associated with the second data structure. The second data structure may include a data element indicative of a second tokenized PAN associated with a second PAN, second mapping data, and the first device identifier. At step 308, based on the data element of the first data structure and the data element of the second data structure each being indicative of the first device identifier and/or the cross-device electronic wallet identifier, the payment network may generate a first relationship identifier (e.g., reference 104C, 106C, 108C, a memory pointer, a database cross-reference, etc.) that may be stored in a data element of the first data structure.

At step 406, based on the first data structure being associated with the second data structure, the payment network may generate a second relationship identifier comprising a memory address associated with the first data structure. The second relationship identifier may be stored in memory in a data element of the second data structure. At step 408, the payment network may receive a transaction record associated with a purchase of travel arrangements (e.g., airline ticket, bus fare, rail ticket, hotel, rental car, etc.) and comprising the second PAN and a second device identifier. The transaction record may also comprise transaction addenda, which may include information related to the travel arrangements (e.g., one or more travel dates, one or more travel locations, etc.).

The payment network may then determine, based on the second mapping data, the second PAN associated with the second tokenized PAN. Based on the data element of the second data structure indicative of the second relationship identifier, the payment network may determine that the first PAN is associated with the second PAN. Using a portion of the first PAN (e.g., the first 6 digits of the 15 or 16 digit numerical identifier), the payment network may determine that the portion of the first PAN is indicative of a first issuer identifier (e.g., a BIN) associated with a first issuer network. Using a portion of the second PAN (e.g., the first 6 digits of the 15 or 16 digit numerical identifier), the payment network may determine that the portion of the second PAN is indicative of a second issuer identifier (e.g., a BIN) associated with a second issuer network.

At step 410, the payment network may then send the first PAN and one or more portions of the transaction record (e.g., one or more data fields, ISO transaction record fields, etc.) indicative of the transaction addenda to the first issuer network. The first issuer network may subsequently update their respective fraud prevention rules such that transactions initiated using the first PAN (e.g., the first tokenized PAN) at the travel locations on one or more of the travel dates may be prevented from being declined. The payment network may then send the second PAN and one or more portions of the transaction record (e.g., one or more data fields, ISO transaction record fields, etc.) indicative of the transaction addenda to the second issuer network. The second issuer network may subsequently update their respective fraud prevention rules such that transactions initiated using the second PAN (e.g., the second tokenized PAN) at the travel locations on one or more of the travel dates may be prevented from being declined.

Second provisioning data may be received at the payment network. The second provisioning data may indicate a third PAN and a third device identifier. The payment network may store a third tokenized PAN associated with the third PAN, third mapping data (e.g., data cross-referencing the third tokenized PAN with the third PAN), and the third device identifier in memory in a third data structure. The third data structure may include a plurality of data. The payment network may determine that the third device identifier is associated with the cross-device electronic wallet identifier. Based on based on the third device identifier being associated with the cross-device electronic wallet identifier, the payment network may generate a third relationship identifier that may be stored in a data element of the first data structure and the second data structure. The third relationship identifier may be indicative of a memory address associated with the third data structure. Based on the third device identifier being associated with the cross-device electronic wallet identifier, the payment network may store the first relationship identifier in a data element of the third data structure. Further, based on the third device identifier being associated with the cross-device electronic wallet identifier, the payment network may store the second relationship identifier in a data element of the third data structure.

The payment network may receive a second transaction record associated with a purchase of travel arrangements (e.g., airline ticket, bus fare, rail ticket, hotel, rental car, etc.) using the third tokenized PAN and a device associated with the third device identifier. The second transaction record may contain transaction addenda, which may include information related to the travel arrangements. The payment network may then determine, based on third mapping data linking the third tokenized PAN to the third PAN, a value of the third PAN associated with the third tokenized PAN. The payment network may then transmit, based on the data element of the third data structure indicative of the first relationship identifier, a message comprising the second PAN, the at least one travel date, and the at least one travel location to the second issuer network. Additionally, based on the data element of the third data structure indicative of the second relationship identifier, a message comprising the first PAN, the payment network may transmit the at least one travel date and the at least one travel location to the first issuer network.

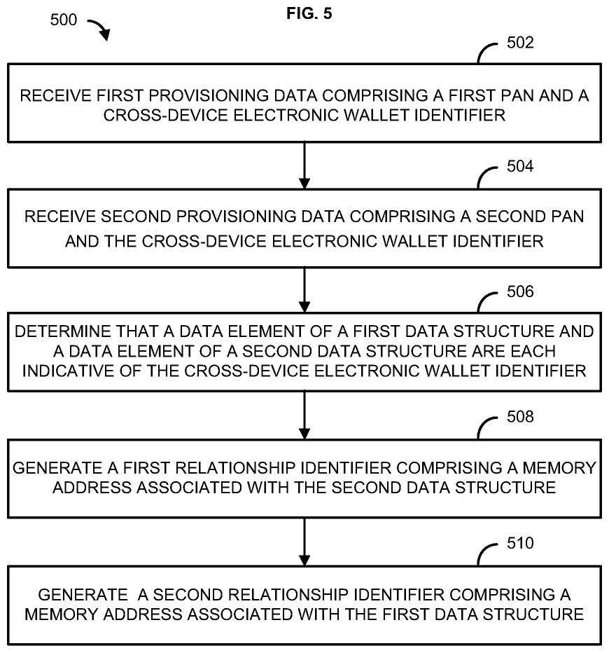

FIG. 5 shows an exemplary method 500 for linking tokenized PANs. At step 502, first provisioning data (e.g., provisioning data 112) may be received at a payment network (e.g., payment network 240) from a user device (e.g., user device 110; user device 202; etc.). The first provisioning data may indicate a first PAN (e.g., debit PAN 104, a unique string of at least fifteen digits, etc.) and a cross-device electronic wallet identifier (e.g., wallet identifier 206) for an electronic wallet associated with more than one user device (e.g., an APPLE PAY wallet, a SAMSUNG PAY wallet, and/or a MASTERCARD MASTERPASS wallet accessible from both a mobile device and a computing device). The payment network may store a first tokenized PAN associated with the first PAN, first mapping data (e.g., data cross-referencing the first tokenized PAN with the first PAN), and the cross-device electronic wallet identifier in memory (e.g., in Token Value 114 and/or Token Vault 224) in a first data structure (e.g., first data structure 104A, Data Structure 226, etc.). The first data structure may include a plurality of data elements (e.g., reference 104C,106C,108C; Data Element 226A and Data Element 226B of Data Structure 226; etc.). The payment network may send the first tokenized PAN to the user device to be stored in an electronic wallet associated with the first device identifier.

At step 504, second provisioning data may be received at the payment network (e.g., payment network 240). The second provisioning data may indicate a second PAN (e.g., credit PAN 106, a unique string of at least fifteen digits, etc.) and the cross-device electronic wallet identifier. The payment network may store a second tokenized PAN associated with the second PAN, second mapping data (e.g., data cross-referencing the second tokenized PAN with the second PAN), and the cross-device electronic wallet identifier in memory (e.g., in Token Value 114 and/or Token Vault 224) in a second data structure (e.g., second data structure 104B, Data Structure 228, etc.). The second data structure may include a plurality of data elements (e.g., reference 104C, 106C, 108C; Data Element 228A and Data Element 228B of Data Structure 228; etc.). The first provisioning data may be received from a first user device, the second provisioning data may be received from a second user device. Both the first user device and the second user device may be associated with the cross-device electronic wallet identifier. The payment network may send the second tokenized PAN to the to one or more of the first user device or second user device to be stored in an electronic wallet associated with the first device identifier.

At step 506, the payment network may determine that a data element of the first data structure and a data element of the second data structure are each indicative of the e cross-device electronic wallet identifier. At step 508, based on the data element of the first data structure and the data element of the second data structure each being indicative of the cross-device electronic wallet identifier, the payment network may generate a first relationship identifier (e.g., reference 104C, 106C, 108C, a memory pointer, a database cross-reference, etc.) that may be stored in a data element of the first data structure. The first relationship identifier may be indicative of a memory address associated with the second data structure. At step 510, based on the data element of the first data structure and the data element of the second data structure each being indicative of the cross-device electronic wallet identifier, the payment network may generate a second relationship identifier, which may be stored in a data element of the second data structure. The second relationship identifier may be indicative of a memory address associated with the first data structure.

After the first PAN and the second PAN are tokenized, the payment network may receive a transaction record (e.g., Travel Data 150, Transaction Data 219, etc.) associated with a purchase of travel arrangements (e.g., airline ticket, bus fare, rail ticket, hotel, rental car, etc.) using the first tokenized PAN. The transaction record may contain transaction addenda, which may include information related to the travel arrangements (e.g., one or more travel dates, one or more travel locations, etc.). The payment network may then determine, based on the first mapping data, the first PAN associated with the first tokenized PAN. The payment network may also determine, based on the second mapping data, the second PAN associated with the second tokenized PAN. Based on the data element of the first data structure indicative of the first relationship identifier, the payment network may determine that the first PAN is associated with the second PAN.

Using a portion of the first PAN (e.g., the first 6 digits of the 15 or 16 digit numerical identifier), the payment network may determine that the portion of the first PAN is indicative of a first issuer identifier (e.g., a BIN) associated with a first issuer network. Using a portion of the second PAN (e.g., the first 6 digits of the 15 or 16 digit numerical identifier), the payment network may determine that the portion of the second PAN is indicative of second issuer identifier (e.g., a BIN) associated with a second issuer network. The payment network may then send the second PAN and one or more portions of the transaction record (e.g., one or more data fields, ISO transaction record fields, etc.) indicative of the transaction addenda to the second issuer network. The second issuer network may subsequently update their respective fraud prevention rules such that transactions initiated using the second PAN (e.g., the second tokenized PAN) at the travel locations on one or more of the travel dates may be prevented from being declined.

Third provisioning data may be received at the payment network. The third provisioning data may indicate (e.g., by one or more data fields of the provisioning data) the first PAN and the cross-device electronic wallet identifier. The payment network may store a third tokenized PAN associated with the third PAN, third mapping data (e.g., data cross-referencing the third tokenized PAN with the third PAN), and the cross-device electronic wallet identifier in memory (e.g., in Token Value 114 and/or Token Vault 224) in a third data structure (e.g., first data structure 104A, Data Structure 226, etc.). The payment network may generate a third relationship identifier that may be stored in a data element of the first data structure as well as a data element of the second data structure. The third relationship identifier may be indicative of a memory address associated with the third data structure. The payment network may then store the second relationship identifier in a data element of the third data structure, based on the data element of the first data structure being indicative of the cross-device electronic wallet identifier. The payment network may further store the first relationship identifier in a data element of the third data structure, based on the data element of the second data structure indicative of the cross-device electronic wallet identifier.

The payment network may receive a second transaction record associated with a purchase of travel arrangements (e.g., airline ticket, bus fare, rail ticket, hotel, rental car, etc.) using the third tokenized PAN. The second transaction record may be contain transaction addenda, which may include information related to the travel arrangements. The payment network may then determine, based on the third mapping data, the third PAN associated with the third tokenized PAN. The payment network may also determine that the third PAN is associated with the first PAN. Further, the payment network may determine that the third PAN is associated with the second PAN.

Using a portion of the third PAN, the payment network may determine that the portion of the third PAN is indicative of a third issuer identifier associated with a third issuer network. The payment network may then send the second PAN and one or more portions of the transaction record indicative of the transaction addenda to the second issuer network. The second issuer network may subsequently update their respective fraud prevention rules such that transactions initiated using the second PAN (e.g., the second tokenized PAN) at the travel locations on one or more of the travel dates may be prevented from being declined. Additionally, the payment network may send the first PAN and one or more portions of the transaction record indicative of the transaction addenda to the first issuer network. The first issuer network may subsequently update their respective fraud prevention rules such that transactions initiated using the first PAN (e.g., the first tokenized PAN) at the travel locations on one or more of the travel dates may be prevented from being declined.

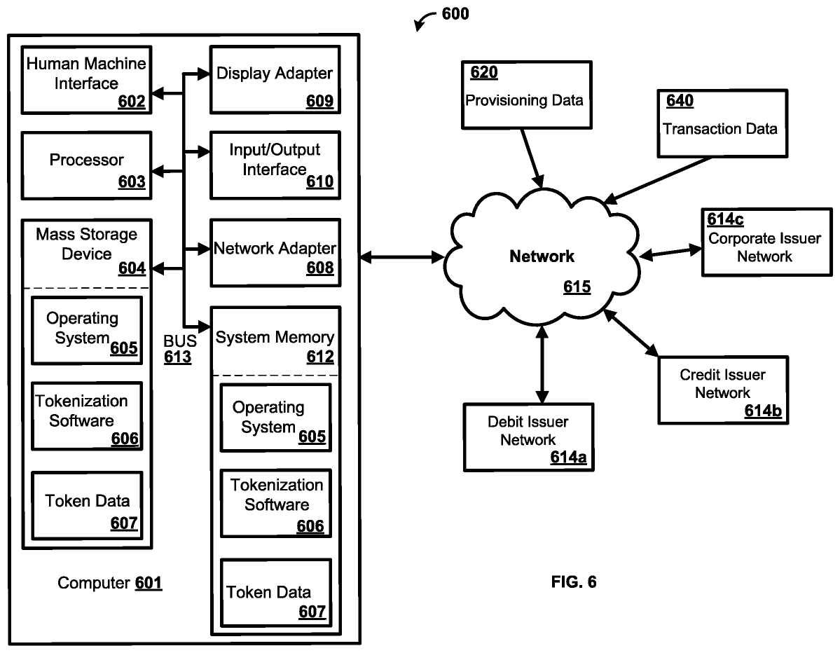

In an exemplary aspect, the methods and systems can be implemented on a computer 601 as illustrated in FIG. 6 and described below. By way of example, user device 110, user device 202, token vault 114, computing device 220, payment network 160 and/or payment network 240 may each be a computer as illustrated in FIG. 6. Similarly, the methods and systems disclosed may utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems may be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 607, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, tokenization software 606, token data 607, a network adapter 608, the system memory 612, an Input/Output Interface 610, a display adapter 609, a display device 611, and a human machine interface 602, may be contained within one or more remote computing devices 614a,b,c at physically separate locations, connected through buses of this form, in effect implementing a fully distributed system.

The computer 601 typically comprises a variety of computer readable media.

Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the token data 607 and/or program modules such as the operating system 605 and the tokenization software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the tokenization software 606. Each of the operating system 705 and the tokenization software 606 (or some combination thereof) can comprise elements of the programming and the tokenization software 606. The token data 607 can also be stored on the mass storage device 604. The token data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c (e.g., such one or more payment devices and/or electronic wallet devices) may be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the tokenization software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

A cardholder may tokenize a payment card stored in an electronic wallet. The computer 601 may receive provisioning data 620 via network 615. The provisioning data 620 may include a first PAN and a first device identifier. The provisioning data 620 may be associated with a first token (e.g., token number, token identifier, etc.) generated using Tokenization Software 606. The first token may be associated with the identifier for the user device, the first PAN, first mapping data (e.g., data cross-referencing the first token with the first PAN 104), and the first device identifier for the user device (e.g., Token Data 607) may be stored in a first data structure (e.g., first data structure 104A, Data Structure 226, etc.) in the Mass Storage Device 604.

The computer 601 may receive a Transaction Data 640 (e.g., Travel Data 150, Transaction Data 219, etc.) via network 615 and associated with a purchase of travel arrangements (e.g., airline ticket, bus fare, rail ticket, hotel, rental car, etc.) using the first tokenized PAN. The transaction record be contain transaction addenda, which may include information related to the travel arrangements (e.g., one or more travel dates, one or more travel locations, etc.). Using a portion of the first PAN (e.g., the first 6 digits of the 15 or 16 digit numerical identifier), the computer 601 may determine that the portion of the first PAN is indicative of a first issuer identifier (e.g., a BIN) associated with Debit Issuer Network 614a. The computer 601 may further determine, based on the Token Data 607 that a second tokenized PAN is associated with the user device and the first tokenized PAN. Using a portion of the second PAN (e.g., the first 6 digits of the 15 or 16 digit numerical identifier), which may be stored in a second data structure logically linked by the computer 601 to the first data structure, the computer 601 may determine that the portion of the second PAN is indicative of second issuer identifier (e.g., a BIN) associated with the Credit Issuer Network 614b. The computer 601 may also determine, based on the Token Data 607 that a third tokenized PAN is associated with the user device and the first tokenized PAN. Using a portion of the third PAN, which may be stored in a third data structure logically linked by the computer 601 to the first data structure, the computer 601 may determine that the portion of the third PAN is indicative of a third issuer identifier (e.g., a BIN) associated with the Corporate Issuer Network 614c.

The computer 601, via network 615, may then send the second PAN and one or more portions of the transaction record (e.g., one or more data fields, ISO transaction record fields, etc.) indicative of the transaction addenda to the Credit Issuer Network 614b. The Credit Issuer Network 614b may subsequently update their respective fraud prevention rules such that transactions initiated using the second PAN (e.g., the second tokenized PAN) at the travel locations on one or more of the travel dates may be prevented from being declined. The computer 601 may also, via network 615, send the third PAN and one or more portions of the transaction record (e.g., one or more data fields, ISO transaction record fields, etc.) indicative of the transaction addenda to the Corporate Issuer Network 614c. The Corporate Issuer Network 614c may subsequently update their respective fraud prevention rules such that transactions initiated using the third PAN (e.g., the third tokenized PAN) at the travel locations on one or more of the travel dates may be prevented from being declined.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving first provisioning data comprising a first primary account number (PAN) and a first device identifier, wherein the first PAN and the first device identifier are stored in memory in a first data structure comprising a plurality of data elements;
receiving second provisioning data comprising a second PAN and the first device identifier, wherein the second PAN and the first device identifier are stored in memory in a second data structure comprising a plurality of data elements;
determining that a data element of the first data structure and a data element of the second data structure are each indicative of the first device identifier;
generating, based on the data element of the first data structure and the data element of the second data structure each being indicative of the first device identifier, a first relationship identifier comprising a memory address associated with the second data structure, wherein the first relationship identifier is stored in a data element of the first data structure; and
generating, based on the data element of the first data structure and the data element of the second data structure each being indicative of the first device identifier, a second relationship identifier comprising a memory address associated with the first data structure, wherein the second relationship identifier is stored in a data element of the second data structure.

2. The method of claim 1, wherein the first device identifier is associated with a cross-device electronic wallet identifier.

3. The method of claim 2, wherein the first provisioning data is received from a first user device associated with the cross-device electronic wallet identifier, and wherein the second provisioning data is received from a second user device associated with the cross-device electronic wallet identifier.

4. The method of claim 1, wherein the first PAN and the second PAN each comprise a unique string of at least fifteen digits.

5. The method of claim 4, further comprising:
receiving a transaction record comprising the first PAN, one or more travel dates, and one or more travel locations;
determining, based on the data element of the first data structure indicative of the first relationship identifier, that the first PAN is associated with the second PAN;
determining, based on the first six digits of the first PAN and the first six digits of the second PAN, that the first PAN is associated with a first issuer network and the second PAN is associated with a second issuer network; and
transmitting, to the second issuer network, a message comprising the second PAN, the one or more travel dates, and the one or more travel locations.

6. The method of claim 4, further comprising:
receiving third provisioning data comprising the first PAN and a second device identifier, wherein the second device identifier is stored in a data element of the first data structure;
determining that a data element of the first data structure and a data element of a third data structure are each indicative of the second device identifier, wherein the third data structure is associated with a third PAN;
generating, based on the data element of the first data structure and the data element of the third data structure each being indicative of the second device identifier, a third relationship identifier comprising a memory address associated with the third data structure, wherein the third relationship identifier is stored in a data element of the first data structure; and
generating, based on the data element of the first data structure and the data element of the third data structure each being indicative of the second device identifier, a fourth relationship identifier comprising a memory address associated with the first data structure, wherein the fourth relationship identifier is stored in a data element of the third data structure.

7. The method of claim 6, further comprising:
receiving a transaction record comprising the first PAN, the second device identifier, one or more travel dates, and one or more travel locations;
determining, based on the data element of the first data structure indicative of the third relationship identifier, that the first PAN is associated with the third PAN;
determining, based on the data element of the first data structure indicative of the first relationship identifier, that the first PAN is associated with the second PAN;
determining, based on the respective first six digits of the first PAN, the second PAN, and the third PAN, that the first PAN is associated with a first issuer network, the second PAN is associated with a second issuer network, and the third PAN is associated with a third issuer network;
transmitting, to the second issuer network, a message comprising the second PAN, the one or more travel dates, and the one or more travel locations; and
transmitting, to the third issuer network, a message comprising the third PAN, the one or more travel dates, and the one or more travel locations.

8. A method comprising:
receiving provisioning data comprising a first primary account number (PAN) and a first device identifier, wherein the first device identifier and the first PAN are each stored in memory in respective data elements of a first data structure;
determining, based on a data element of the first data structure indicative of a first relationship identifier, that the first data structure is associated with a second data structure comprising a data element indicative of a second PAN, wherein the first relationship identifier comprises a memory address associated with the second data structure;
generating, based on the first data structure being associated with the second data structure, a second relationship identifier comprising a memory address associated with the first data structure, wherein the second relationship identifier is stored in memory in a data element of the second data structure;
receiving a transaction record comprising the second PAN, a second device identifier, one or more travel dates, and one or more travel locations; and
transmitting, to a first issuer network, a message comprising the first PAN, the one or more travel dates, and the one or more travel locations.

9. The method of claim 8, wherein the first PAN and the second PAN each comprise a unique string of at least fifteen digits.

10. The method of claim 9, further comprising:
determining, based on the data element of the second data structure indicative of the second relationship identifier, that the second PAN is associated with the first PAN; and
determining, based on the respective first six digits of the first PAN and the second PAN, that the first PAN is associated with a first issuer network and the second PAN is associated with a second issuer network.

11. The method of claim 10, further comprising:
transmitting, to the second issuer network, a message comprising the second PAN, the one or more travel dates, and the one or more travel locations.

12. The method of claim 11, wherein the first device identifier is associated with a cross-device electronic wallet identifier.

13. The method of claim 12, further comprising:
receiving second provisioning data comprising a third PAN and a third device identifier, wherein the third device identifier and the third PAN are each stored in memory in respective data elements of a third data structure, and wherein the third PAN comprises a unique string of at least fifteen digits;
determining that the third device identifier is associated with the cross-device electronic wallet identifier;
generating, based on the third device identifier being associated with the cross-device electronic wallet identifier, a third relationship identifier comprising a memory address associated with the third data structure, wherein the third relationship identifier is stored in a data element of the first data structure and a data element of the second data structure;
storing, based on the third device identifier being associated with the cross-device electronic wallet identifier, the first relationship identifier in a data element of the third data structure; and
storing, based on the third device identifier being associated with the cross-device electronic wallet identifier, the second relationship identifier in a data element of the third data structure.

14. The method of claim 13, further comprising:
receiving a second transaction record comprising the third PAN, the third device identifier, at least one travel date, and at least one travel location;
transmitting, based on the data element of the third data structure indicative of the first relationship identifier, a message comprising the second PAN, the at least one travel date, and the at least one travel location to the second issuer network; and
transmitting, based on the data element of the third data structure indicative of the second relationship identifier, a message comprising the first PAN, the at least one travel date, and the at least one travel location to the first issuer network.

15. A method comprising:
receiving first provisioning data comprising a first primary account number (PAN) and a cross-device electronic wallet identifier, wherein the first PAN and the cross-device electronic wallet identifier are each stored in memory in respective data elements of a first data structure;
receiving second provisioning data comprising a second PAN and the cross-device electronic wallet identifier, wherein the second PAN and the cross-device electronic wallet identifier are each stored in memory in respective data elements of a second data structure;
determining that a data element of the first data structure and a data element of the second data structure are each indicative of the cross-device electronic wallet identifier;
generating, based on the data element of the first data structure and the data element of the second data structure each being indicative of the cross-device electronic wallet identifier, a first relationship identifier comprising a memory address associated with the second data structure, wherein the first relationship identifier is stored in a data element of the first data structure; and
generating, based on the data element of the first data structure and the data element of the second data structure each being indicative of the cross-device electronic wallet identifier, a second relationship identifier comprising a memory address associated with the first data structure, wherein the second relationship identifier is stored in a data element of the second data structure.

16. The method of claim 15, wherein the first provisioning data is received from a first user device associated with the cross-device electronic wallet identifier, and wherein the second provisioning data is received from a second user device associated with the cross-device electronic wallet identifier.

17. The method of claim 16, wherein the first PAN and the second PAN each comprise a unique string of at least fifteen digits.

18. The method of claim 17, further comprising:
receiving a transaction record comprising the first PAN, one or more travel dates, and one or more travel locations;
determining, based on the data element of the first data structure indicative of the first relationship identifier, that the first PAN is associated with the second PAN;
determining, based on the first six digits of the first PAN and the first six digits of the second PAN, that the first PAN is associated with a first issuer network and the second PAN is associated with a second issuer network; and
transmitting, to the second issuer network, a message comprising the second PAN, the one or more travel dates, and the one or more travel locations.

19. The method of claim 18, further comprising:
receiving third provisioning data comprising a third PAN and the cross-device electronic wallet identifier, wherein the third PAN and the cross-device electronic wallet identifier are each stored in memory in respective data elements of a third data structure;
generating a third relationship identifier comprising a memory address associated with the third data structure, wherein the third relationship identifier is stored in a data element of the first data structure and a data element of the second data structure;
storing, based on the data element of the first data structure indicative of the cross-device electronic wallet identifier, the second relationship identifier in a data element of the third data structure; and
storing, based on the data element of the second data structure indicative of the cross-device electronic wallet identifier, the first relationship identifier in a data element of the third data structure.

20. The method of claim 19, further comprising:
receiving a second transaction record comprising the third PAN, the cross-device electronic wallet identifier, at least one travel date, and at least one travel location;
transmitting, based on the data element of the third data structure indicative of the first relationship identifier, a message comprising the second PAN, the at least one travel date, and the at least one travel location to the second issuer network; and
transmitting, based on the data element of the third data structure indicative of the second relationship identifier, a message comprising the first PAN, the at least one travel date, and the at least one travel location to the first issuer network.
